(19) United States
(12) Patent Application Publication
(10) Pub. No.: US 2010/0172728 A1
(43) Pub. Date: Jul. 8, 2010

(54) STORAGE AND RETRIEVAL MACHINE

(76) Inventor: Hiroyuki Amada, Yokohama-shi (JP)

Correspondence Address: OSTROLENK FABER GERB & SOFFEN, 1180 AVENUE OF THE AMERICAS, NEW YORK, NY, 100368403, US

(21) Appl. No.: 12/665,944

(22) PCT Filed: Jun. 23, 2008
(86) PCT No.: PCT/JP2008/061397

§ 371 Date: Dec. 22, 2009

(30) Foreign Application Priority Data
Jun. 25, 2007 (JP) 2007-166000

(51) Int. Cl. B65G 1/06; B66F 9/07; B66F 9/075; B66F 9/06

(52) U.S. Cl. 414/659

(57) ABSTRACT

A mast extends downward of the upper surface of a lower frame, guide portions that are capable of moving by sliding on a wall surface of the mast are plurally arranged in the elevating/lowering direction of the elevating/lowering portion, a lower frame is provided with a guide portion movement region A that enables movement of the lowermost guide portion among the guide portions to move downward of the upper surface of the lower frame. According to the present invention, it is possible to space apart the guide portions without lowering the storage efficiency of cargoes in an automated warehouse.

### TECHNICAL FIELD

The present invention relates to a storage and retrieval machine, and in particular to a storage and retrieval machine that is provided with guide portions that are capable of moving by sliding on a mast that is installed erect on a lower frame.

Priority is claimed on Japanese Patent Application No. 2007-166000, filed Jun. 25, 2007, the content of which is incorporated herein by reference.

### BACKGROUND ART

For example, in an automated warehouse that keeps cargo on a plurality of storage shelves arranged in parallel in the vertical direction and the horizontal direction, conveying of the cargo is performed using a storage and retrieval machine. This storage and retrieval machine travels on a path that is established along the cargo housing shelves, and is capable of performing transfer of cargo between any storage shelves by elevating/lowering a carriage that is suspended via an elevating/lowering wire rope with a drive device.

This kind of storage and retrieval machine is provided with a mast that is installed erect on a lower frame, and by installing side rollers (guide portions) that are capable of moving vertically by sliding on the mast in an elevating/lowering portion, elevating/lowering of the elevating/lowering portion is enabled along the mast.

[Patent Document 1] Japanese Unexamined Patent Application, First Publication No. 2000-142917

In a storage and retrieval machine, the transfer of cargo between the elevating/lowering portion and the outside (for example, a storage shelf) is performed using a transport device that is installed on the elevating/lowering portion, but in the case of causing a cargo to move horizontally using the transport device, the storage and retrieval machine is decentered, and an offset load acts on the side roller.

For this reason, there is a need for the side roller to be designed so as to be able to withstand such an offset load.

Note that in the case of a plurality of side rollers being arranged in the vertical direction of the mast, it is known that by further spacing apart the side rollers, the offset load that acts on each side roller becomes smaller. As a result of the offset load that acts on each side roller decreasing in this way, it is possible to reduce the rigidity of the support body that supports the side roller, and possible to reduce the rigidity of the side rollers themselves, and thereby it becomes possible to achieve a reduction in the weight and manufacturing cost of the storage and retrieval machine.

However, in an automated warehouse that is provided with a storage and retrieval machine, raising the cargo storage efficiency is regarded as an important technical issue.

Since the side roller moves by sliding on the wall surfaces of the mast that is installed on the lower frame, in a conventional storage and retrieval machine, it is only capable of moving within a range from the upper surface of the lower frame to the top end of the mast. That is, in a conventional storage and retrieval machine, the position at which the lowermost side roller has been lowered until the upper surface position of the lower frame is the position at which the elevating/lowering portion has been lowered the most, and the position at which the uppermost side roller has been raised until the top end of the mast is the position at which the elevating/lowering portion has been raised the most. For this reason, when the space between the side rollers is widened, the distance in which the elevating/lowering portion can be raised and lowered becomes shorter, and so the cargo storage efficiency drops.

Accordingly, a conventional storage and retrieval machine has a structure that is capable of withstanding offset loads during cargo transfer by increasing the rigidity of the support body that supports the side rollers and increasing the rigidity of the side rollers themselves without being able to widen the space between the side rollers.

The present invention was achieved in view of the aforementioned circumstances, and has as its object to enable spacing apart of the guide portions in a storage and retrieval machine without lowering the cargo storage efficiency in an automated warehouse.

### DISCLOSURE OF THE INVENTION

In order to achieve the aforementioned object, the present invention is a storage and retrieval machine provided with a lower frame, a mast that is installed erect on the lower frame, a guide portion that is capable of moving by sliding on a wall surface of the mast, an elevating/lowering portion that is capable of being elevated/lowered along the mast by being fixed to the guide portion and that holds a cargo; and a transport device that is installed on the elevating/lowering portion and that performs transfer of the cargo between the elevating/lowering portion and the outside, in which the mast extends downward from the upper surface of the lower frame; a plurality of the guide portions are arranged in the elevating/lowering direction of the elevating/lowering portion; and the lower frame is provided with a guide portion movement region that enables movement of at least the lowermost guide portion among the plurality of the guide portions to move downward of the upper surface of the lower frame.

According to the present invention having this kind of characteristic, by the mast that is extended downward of the upper surface of the lower frame and the guide portion movement region, at least the lowermost guide portion among the plurality of guide portions is enabled to move downward of the upper surface of the lower frame.

Also, in the present invention, the constitution may be adopted in which the lower frame has a frame shape, and the through region in the central portion of the lower frame is the guide portion movement region.

Also, in the present invention, the constitution may be adopted in which the elevating/lowering portion is provided with side frames to which the guide portions are fixed, and a main frame that is fixed to the side frames and on which the transport device is installed, in which at least the lowermost guide portion among the plurality of the guide portions is installed to protrude downward of the side frame.

Also, in the present invention, the constitution may be adopted in which two of the masts are installed erect in parallel on the lower frame, a plurality of the guides are arranged in the elevating/lowering direction of the elevating/lowering portion with respect to each mast, and the elevating/lowering portion can be elevated/lowered between the masts.

### Effect of the Invention

According to the present invention, by the mast that is extended downward of the upper surface of the lower frame and the guide portion movement region, at least the lowermost guide portion among the plurality of guide portions is enabled to move downward of the upper surface of the lower frame. For this reason, it is possible to ensure a longer movement region of the guide portions than a conventional storage and retrieval machine by just the portion of the guide portion movement region.

Accordingly, in the storage and retrieval machine according to the present invention, it is possible to space apart guide portions in a storage and retrieval machine without lowering the cargo storage efficiency in an automated warehouse.

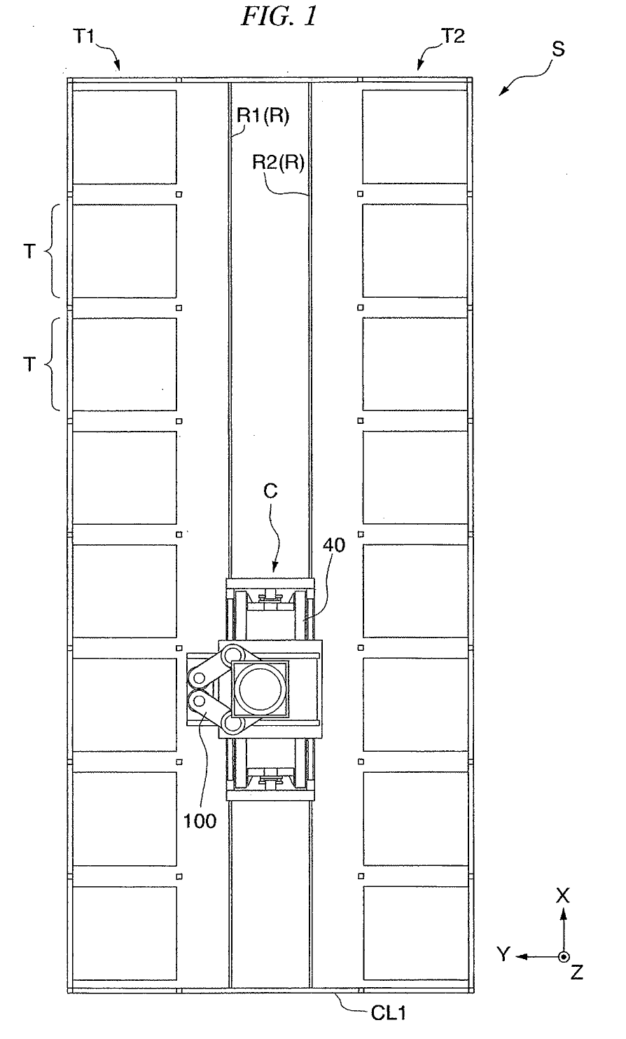

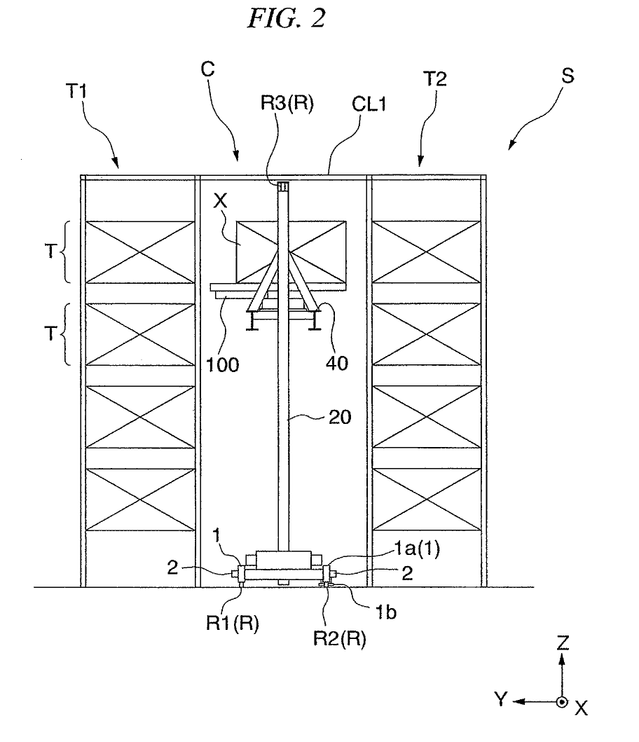

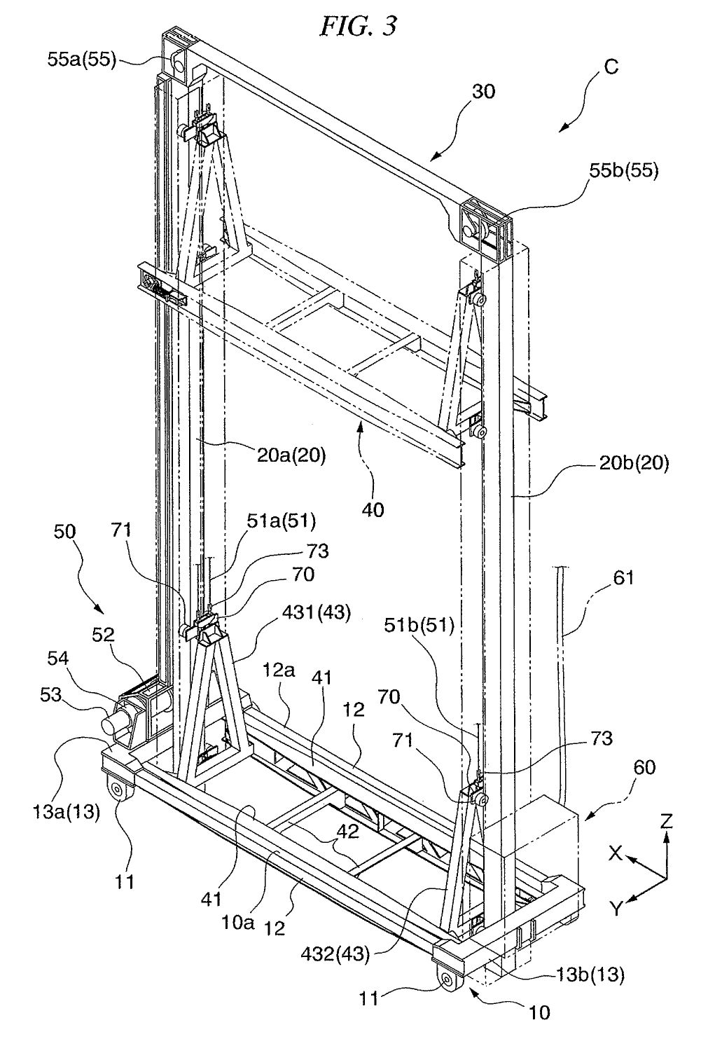

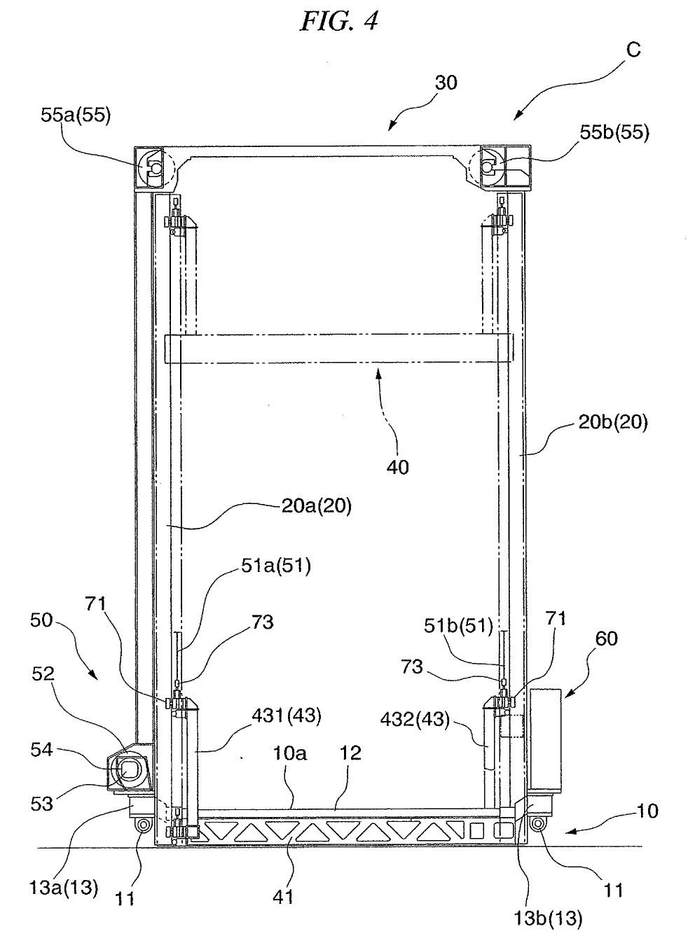

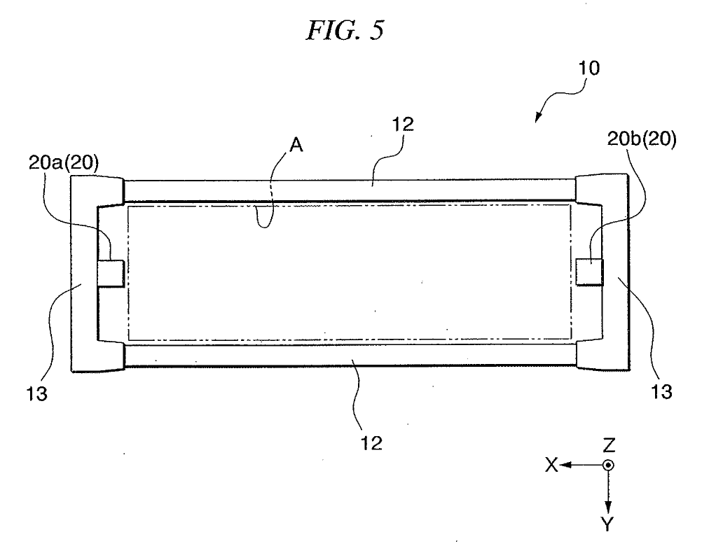

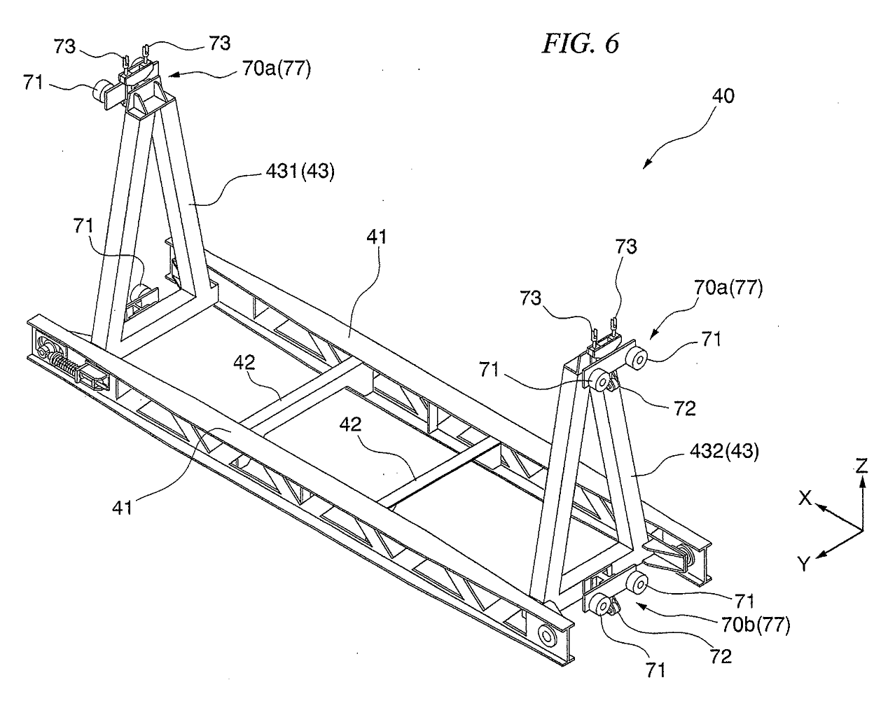

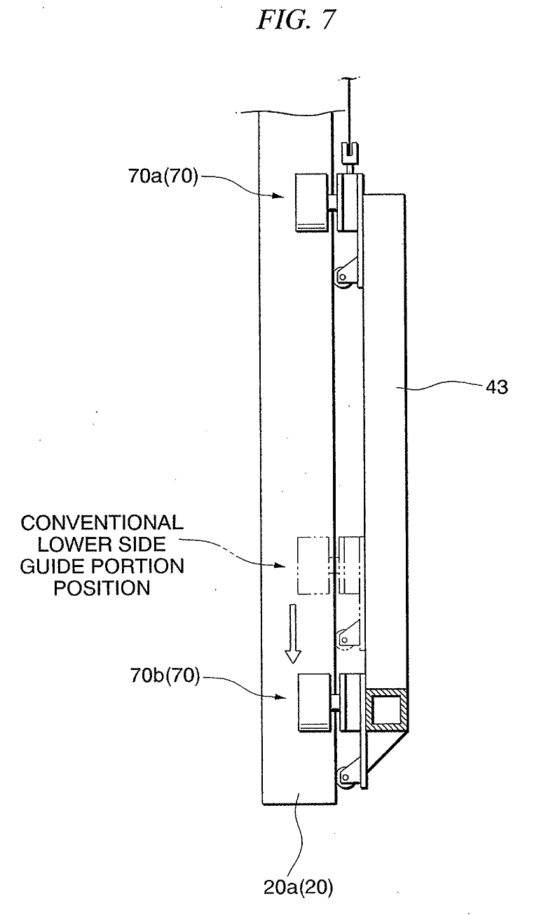

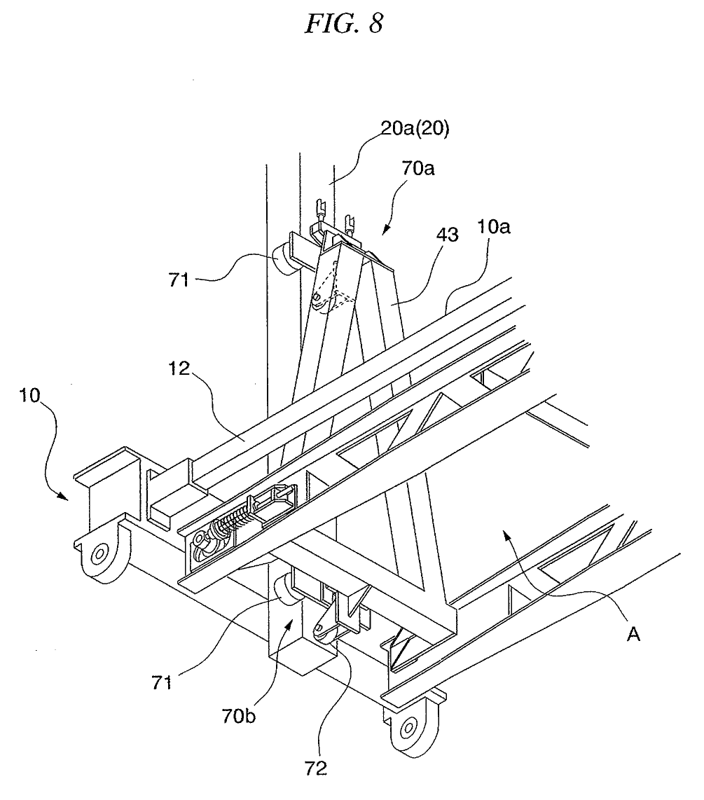

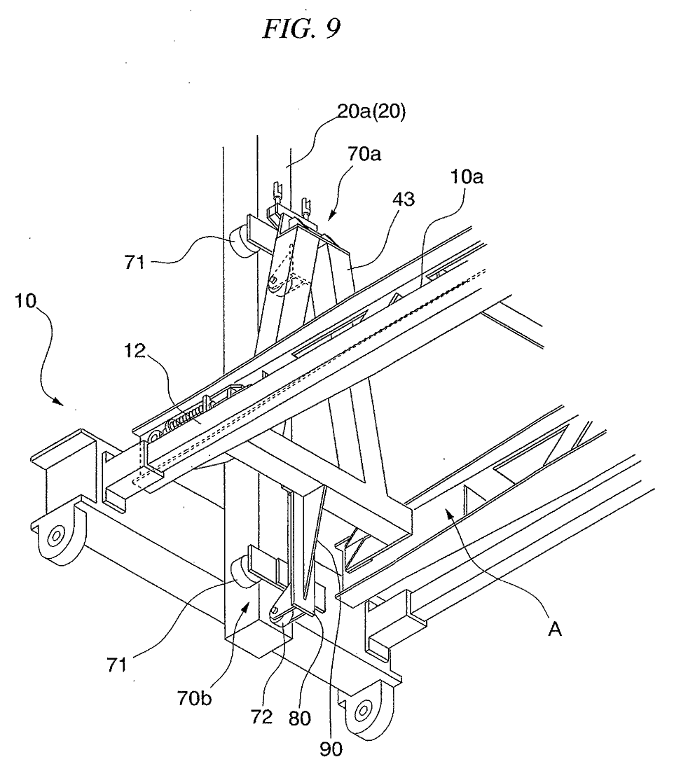

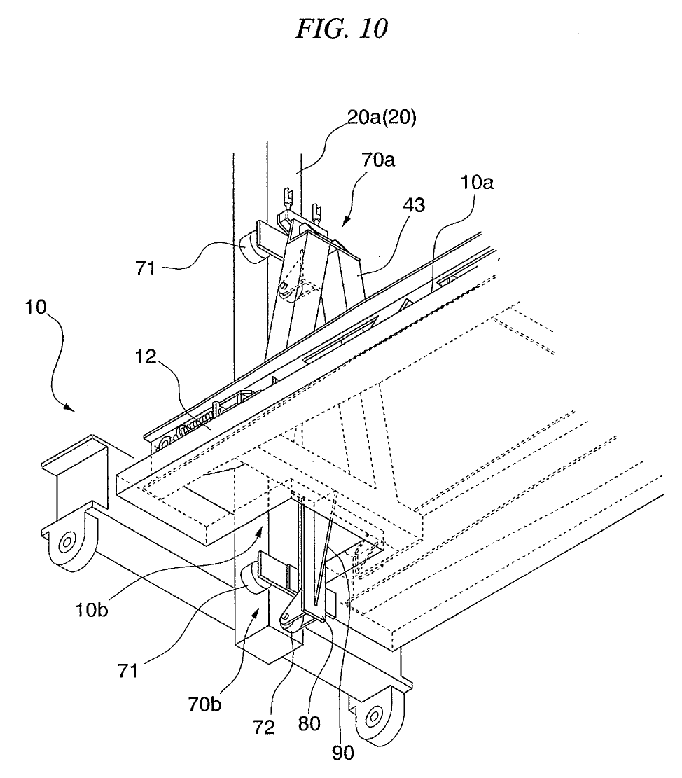

### BRIEF DESCRIPTION OF THE DRAWINGS

[FIG. 1] A plan drawing of an automated warehouse that is provided with a storage and retrieval machine that is the first embodiment of the present invention.

[FIG. 2] A side drawing of the automated warehouse that is provided with a storage and retrieval machine that is the first embodiment of the present invention.

[FIG. 3] A perspective drawing of the storage and retrieval machine that is the first embodiment of the present invention.

[FIG. 4] A front drawing of the storage and retrieval machine that is the first embodiment of the present invention.

[FIG. 5] A plan drawing that schematically shows the lower frame that the storage and retrieval machine that is the first embodiment of the present invention is provided with.

[FIG. 6] A perspective drawing of a carriage that the storage and retrieval machine that is the first embodiment of the present invention is provided with.

[FIG. 7] A drawing for comparing the storage and retrieval machine that is the first embodiment of the present invention and a conventional storage and retrieval machine.

[FIG. 8] A perspective drawing viewed from below of the storage and retrieval machine that is the first embodiment of the present invention.

[FIG. 9] A perspective drawing viewed from below of the storage and retrieval machine that is the second embodiment of the present invention.

[FIG. 10] A perspective drawing viewed from below of the storage and retrieval machine that is the third embodiment of the present invention.

### DESCRIPTION OF REFERENCE NUMERALS

C storage and retrieval machine
20 (20a, 20b) mast
70 (70a, 70b) guide portion
40 carriage (elevating/lowering portion)
100 transport device
A region (guide portion movement region)
X cassette (cargo)

### BEST MODE FOR CARRYING OUT THE INVENTION

Hereinbelow, one embodiment of the storage and retrieval machine according to the present invention shall be described with reference to the drawings. Note that in the following drawings, the dimensions of each member are suitably altered in order to make each member a size that can be recognized.

### First Embodiment

FIG. 1 is a plan view of an automated warehouse S that is provided with a storage and retrieval machine C of the present embodiment. Also, FIG. 2 is a side view of the automated warehouse S.

As shown in these drawings, the automated warehouse S is provided with the storage and retrieval machine C, and racks T1 and T2 that are oppositely arranged sandwiching a rail R that is the path of the storage and retrieval machine C, and conveys cargo to the racks T1 and T2 by the storage and retrieval machine C to be stored. Also, the automated warehouse S is provided with a carry-in conveyor (not shown) for carrying in cargo and a carry-out conveyor (not shown) for carrying out cargo, and it is possible to perform transfer of cargo between the carry-in conveyor and the carry-out conveyor by the storage and retrieval machine C.

Note that in the present embodiment, the cargo is a cassette X that stores a plurality of glass substrates, and the racks T1, T2 and the storage and retrieval machine C are for example installed in a clean room CL1 with a clean level of 10.

The racks T1 and T2 are constituted by storage shelves T that are arranged in a plurality in the horizontal direction and the vertical direction, and are made to be capable of holding the cassettes X on the storage shelves T. That is, the racks T1 and T2 are constituted by the storage shelves T that are arranged in multiple stages. Also, the mutually facing sides of the racks T1 and T2 are constituted as an entryway and exitway for the cassette X.

Note that in the following description, the case shall be described in which the arrangement direction of the storage shelve T in the horizontal direction is the X direction, the horizontal direction that is perpendicular to the X direction is the Y direction, and the vertical direction that is perpendicular to the X and Y planes is the Z direction.

The rails R extend in the X direction, that is, are laid along the racks T1 and T2, and are constituted by rails R1 and R2 that are laid in parallel with a predetermined interval on the floor of the clean room CL1 and a rail R3 that is laid on the ceiling of the clean room CL1.

The storage and retrieval machine C is provided with four wheels 1 that are supported from below by the rails R1 and R2 and are capable of rotating on the rails R1 and R2. A motor 2 is connected to each wheel 1, and by driving the motor 2, the wheels 1 are rotated, and the storage and retrieval machine C travels along the rails R1 and R2. Note that a guide roller 1b that abuts both side surfaces of the rail R2 is installed at a wheel 1a that rotates on the rail R2 among the wheels 1, and the wheel 1a is guided on the rail R2 by the guide roller 1b.

Also, the storage and retrieval machine C is provided with a carriage 40 that is elevated/lowered (elevating/lowering portion), and by a transport device 100 (for example, a fork device) that is installed on the carriage 40, transfer of the cassette X is performed between the carriage 40 and the storage shelf T, and between the carriage 40 and the carry-in conveyor and between the carriage 40 and the carry-out conveyor.

Referring to FIG. 3 to FIG. 8, the storage and retrieval machine C shall be described in detail.

FIG. 3 is a perspective view of the storage and retrieval machine C. Also, FIG. 4 is a front view of the storage and retrieval machine. In addition, in FIG. 3 and FIG. 4, in order to enhance the recognition of the drawing, the illustration of the wheel 1, the motor 2, the guide roller 1b, and the transport device 100 that the storage and retrieval machine C is equipped with has been omitted.

As shown in these drawings, the storage and retrieval machine C is provided with a lower frame 10 (mast support frame), a mast 20, an upper frame 30, a carriage 40, a drive device 50, and a control device 60.

The lower frame 10 serves as a base that has a wheel mounting part 11 on which the above-mentioned wheel 1 is installed so as to rotate freely.

FIG. 5 is a plan view that schematically shows the lower frame 10. As shown in this drawing, the lower frame 10 has two main frames 12 that extend in the X direction and are arranged in parallel, and two side frames 13 that connect the end portions of the two main frames, and constitutes a lower frame 10 having a closed frame shape.

The main frames 12 are disposed spaced apart wider than the width (width in the Y direction) of the carriage 40 described below and narrower than the width (width in the Y direction) of the cassette X, and the transport device 100 is installed. Also, the side frames 13 are disposed spaced apart wider than the length (length in the X direction) of the carriage 40. For this reason, a region A (guide portion movement region) in which the carriage 40 is capable of entering from above is formed in the center of the lower frame 10 by the main frames 12 and the side frames 13.

Along with the carriage 40, guide portions 70b (lowermost guide portion) described below are also made to be capable of entering this region A. That is, the region A (through region) that vertically passes through the central portion of the lower frame 10 serves as the guide portion movement region of the present invention.

Returning to FIG. 3 and FIG. 4, the mast 20 is installed erect with respect to the lower frame 10, and is constituted by a mast 20a that is installed on one side frame 13a of the lower frame 10 and a mast 20b that is installed on the other side frame 13b of the lower frame 10.

Also, the mast 20 is extended so as to project to the lower side of the lower frame 10. That is, the mast 20 is extended from the upper surface 10a of the lower frame 10 to the installation surface (floor surface of the clean room CL1) at which the rails R1 and R2 are laid.

Note that the mast 20a and the mast 20b are arranged in the X direction. That is, the two masts 20a and 20b are installed erect on the lower frame 10 in a parallel manner.

This mast 20 has a square pillar shape, and it is erected so that each side surface thereof is parallel with the X direction or the Y direction. Then, the mast 20, as shown in FIG. 5, is fixed in the state of a side surface being abutted against the side portion of the side frame 13, whereby it is installed in a state of projecting from the side frame 13 of the lower frame 10 to the aforementioned region A side.

The upper frame 30 connects the top end portion of the mast 20a and the top end portion of the mast 20b, and is disposed extending in the X direction.

In approximately the central portion of this upper frame 30, a guide roller (not illustrated) is installed for preventing leaning in the Y direction of the storage and retrieval machine C by holding the rail R3 from both sides.

FIG. 6 is a perspective view of the carriage 40. As shown in this drawing, the carriage 40 has two main frames 41 that extend in the X direction. The main frames 41 are connected by reinforcing members 42. Side frames 43 are connected to both end portions of the main frames 41.

Each side frame 43 has an approximate triangular shape that is raised in the Z direction, and the two main frames 41 are connected to the base portion thereof.

Two guide portions 70 that are arranged in the Z direction (the elevating/lowering direction of the carriage 40) are fixed to each side frame 43.

In the guide portion 70 are installed side rollers 71 that hold the mast 20 from both sides from the Y direction and a compact guide roller 72 that abuts the mast 20 from the X direction. These side rollers 71 and the guide roller 72 are enabled to move by sliding along the side surfaces of the mast 20, and by being guided by these side rollers 71 and the guide roller 72, the side frame 43, and moreover the carriage 40, is enabled to move in the vertical direction (Z direction) along the mast 20.

Then, among the guide portions 70 that are installed on each side frame 43 in this way, the interval between the upper guide portion 70a and the lower guide portion 70b is set to be longer than a conventional storage and retrieval machine, as shown in FIG. 7.

Note that in the guide portion 70a (70) that is fixed to the top portion of the side frame 43, connecting portions 73 are installed to which are connected elevating/lowering wire ropes 51 that a drive device 50 described below is provided with.

Returning to FIG. 3 and FIG. 4, the drive device 50 is provided with an elevating/lowering wire rope 51, a drum 52, a motor 53, and a decelerator 54.

One end of the elevating/lowering wire rope 51 is connected to the connection portion 73 of the guide portion 70 that the side frame 43 of the carriage 40 is provided with, and the other end is wound around the drum 52. Also, as the elevating/lowering wire rope 51, an elevating/lowering wire rope 51a that is connected to the guide portion 70a of the side frame 431 that is positioned on the mast 20a side and an elevating/lowering wire rope 51b that is connected to the guide portion 70a of the side frame 432 that is positioned on the mast 20b side exist, but the other end of either elevating/lowering wire rope 51a or 51b is wound around the drum 52.

Note that at the top of the mast 20a and the top of the mast 20b, a sheave 55 for guiding the elevating/lowering wire rope 51 is installed. A sheave 55a that is installed at the top portion of the mast 20a is made to rotate freely within the X and Z planes, and guides the elevating/lowering wire rope 51a to the guide portion 70a that is fixed to the side frame 431, and guides the elevating/lowering wire rope 51b to the sheave 55b that is installed at the top portion of the mast 20b. The sheave 55b that is installed at the top portion of the mast 20b is made to rotate freely within the X and Z planes, and guides the elevating/lowering wire rope 51b to the guide portion 70a that is fixed to the side frame 432.

The drum 52 is installed in a rotatable manner centered on a rotation axis facing the Y direction on the side frame 13a of the lower frame 10.

The motor 53 is connected with the drum 52 via the decelerator 54, and rotates the drum 52 via the decelerator 54. Note that the drum 53 and the decelerator 54 are respectively installed at both ends of the drum 52.

The control device 60 controls the operation of the entire storage and retrieval machine C, and is installed on the side frame 13b of the lower frame 10. Note that the control device 60 controls the drive device 50 and the transport device 100 of the storage and retrieval machine C via a cable 61, and furthermore is electrically connected with an external control device that controls the entire automatic warehouse S.

In such a storage and retrieval machine C, as shown in FIG. 5, by controlling the motor 53 to adjust the rotation amount of the drum 52, the amount of winding of the elevating/lowering wire rope 51 is changed, and the height of the side frames 43 of the carriage 40 connected to the elevating/lowering wire rope 51 is thereby adjusted. That is, the height of the carriage 40 is controlled by the driving of the drive device 50. By the adjustment of the travel position of the storage and retrieval machine C and the height of the carriage 40, the transfer of the cassette X by the transport device 100 that is mounted on the carriage 40 is performed.

Here, in the storage and retrieval machine C of the present embodiment, the interval between the upper guide portion 70a and the lower guide portion 70b is set to be longer than in a conventional storage and retrieval machine, as shown in FIG. 7.

In the case of the interval between the upper guide portion 70a and the lower guide portion 70b being wide, during the transfer of the cassette X by the transport device 100, the offset load that acts on the guide portion 70 (particularly the side roller 71) is dispersed and reduced. For this reason, compared to a conventional storage and retrieval machine, it is possible to reduce the rigidity of for example the side roller 71 and the support body that supports the side roller 71, and it becomes possible to achieve a reduction in the weight and the manufacturing cost of the storage and retrieval machine.

In the storage and retrieval machine C of the present embodiment, the lower frame 10 is made to have a frame shape, and in the central portion thereof, the region A is formed that enables movement of the guide portion 70b to move downward of the upper surface 10a of the lower frame 10.

For this reason, as shown in FIG. 8, it is possible to move the guide portion 70b for each carriage 40 lower than the upper surface 10a of the lower frame 10 by the region A, and it is possible to offset the increment in the interval between the upper guide portion 70a and the lower guide portion 70b. Thereby, the distance of possible elevation and lowering of the carriage 40 of the present embodiment does not become shorter than a conventional storage and retrieval machine. For this reason, there is no reduction in the storage efficiency of the cassettes X in the automated warehouse S.

According to the storage and retrieval machine C of the present embodiment, the lower guide portion 70b is enabled to move downward of the upper surface 10a of the lower frame 10 by the masts 20a, 20b that are extended further downward than the upper surface 10a of the lower frame 10 and the region A that is formed in the lower frame 10. For this reason, it is possible to ensure the movement region of the guide portion 70 longer than a conventional storage and retrieval machine.

Accordingly, according to the present embodiment, it is possible to space apart the guide portions in a storage and retrieval machine without lowering the cargo storage efficiency in an automated warehouse.

### Second Embodiment

Next, the second embodiment of the present invention shall be described. Note that in the description of the second embodiment, descriptions of portions similar to the first embodiment shall be omitted or abbreviated.

FIG. 9 is a perspective view seen from below of the lowered state of the carriage 40 in the storage and retrieval machine of the present embodiment.

In the first embodiment, the description was given for the configuration of making the side frame 43 itself long in the vertical direction in order to make the interval between the guide portion 70a and the guide portion 70b longer than before.

In contrast, the storage and retrieval machine of the present embodiment adopts a structure in which the lower guide portion 70b protrudes below the side frame without making the side frame 43 longer, as shown in FIG. 9.

Specifically, by fixing the guide portion 70b to a support body 80 that is projected to extend downward of the side frame 43 and reinforcing the support body 80 with a rib 90, the guide portion 70b is installed downward of the side frame 43.

According to the storage and retrieval machine of the present embodiment that has such a constitution, while making the size of the side frame 43 the same as that of a conventional storage and retrieval machine, it is possible to set the interval between the guide portion 70a and the guide portion 70b to be longer than in a conventional storage and retrieval machine.

For this reason, according to the storage and retrieval machine of the present embodiment, it is possible to exhibit the same effect as the storage and retrieval machine of the aforementioned first embodiment and it is possible to make the size of the side frame 43 the same as in a conventional storage and retrieval machine. Accordingly, it is possible to reduce the amount of materials required for forming the side frame 43 compared to the aforementioned first embodiment, and so it is possible to suppress an increase in manufacturing cost.

### Third Embodiment

Next, the third embodiment of the present invention shall be described. Note that in the description of the third embodiment, descriptions of portions similar to the first embodiment or the second embodiment shall be omitted or abbreviated.

FIG. 10 is a perspective view seen from below of the lowered state of the carriage 40 in the storage and retrieval machine of the present embodiment.

As shown in this drawing, in the storage and retrieval machine of the present embodiment, the lower guide portion 70b protrudes downward of the side frame similarly to the aforementioned second embodiment. In the storage and retrieval machine of the present embodiment, the lower frame 10 is not formed in a frame shape, and a through portion 10b is formed through which only the guide portion 70b, the support body 80 and the reinforcing rib 90 are capable of passing.

According to a storage and retrieval machine of the present embodiment that has such a constitution, in the case of the carriage 40 being lowered, as a result of the guide portion 70b, the support body 80 and the reinforcing rib 90 entering the through portion 10b, the guide portion 70b moves downward of the upper surface 10a of the lower frame 10. For this reason, it is possible to offset the increment in the interval between the upper guide portion 70a and the lower guide portion 70b similarly to the storage and retrieval machine of the aforementioned first embodiment.

Note that in the case of there being sufficient thickness in the lower frame 10, the region for the guide portion 70b to move downward of the upper surface 10a of the lower frame 10 need not necessarily penetrate the lower frame 10. That is, it is possible for the guide portion movement region of the present invention to be constituted from a slot portion in which the bottom opening end of the through portion 10b that the storage and retrieval machine of the third embodiment is provided with is blocked.

Preferred embodiments of the storage and retrieval machine according to the present invention were given above with reference to the drawings, but the present invention is needless to say not limited to the above embodiments. The shapes and combinations or the like of the constituent members shown in the aforementioned embodiments are one example, and various modifications are possible based on design changes within the scope that does not depart from the spirit of the present invention.

For example, in the aforementioned embodiments, the constitution was given in which the two guide portions 70a and 70b are arranged in the elevating/lowering direction of the carriage 40 with respect to each side frame 43.

However, the present invention is not restricted to this, and moreover it is possible to adopt a constitution in which a plurality of guide portions are arranged with respect to each side frame. In the case of adopting such a constitution, at least the guide portion that is positioned at the lowermost portion may be moved downward of the upper surface 10a of the lower frame 10.

Also, in the aforementioned embodiments, the description was given for the constitution in which, among the plurality of guide portions that are arranged, only the guide portion 70b that is positioned at the lowermost portion is enabled to move downward of the upper surface 10a of the lower frame 10.

However, the present invention is not restricted thereto, for example, the upper guide portion 70a may also be enabled to move downward of the upper surface 10a of the lower frame 10. Also, in the case of three or more of the guide portions 70 being installed in one side frame 43, it is possible to adopt a constitution that enables movement of two of them to move downward of the upper surface 10a of the lower frame 10.

### INDUSTRIAL APPLICABILITY

According to the present invention, it is possible to space part guide portions in a storage and retrieval machine without lowering the cargo storage efficiency in an automated warehouse.

1. A storage and retrieval machine provided with a lower frame, a mast that is installed erect on the lower frame, a guide portion that is capable of moving by sliding on a wall surface of the mast, an elevating/lowering portion that is capable of being elevated/lowered along the mast by being fixed to the guide portion and that holds a cargo; and a transport device that is installed on the elevating/lowering portion and that performs transfer of the cargo between the elevating/lowering portion and the outside, wherein
the mast extends downward from the upper surface of the lower frame;
a plurality of the guide portions are arranged in the elevating/lowering direction of the elevating/lowering portion; and
the lower frame is provided with a guide portion movement region that enables movement of at least the lowermost guide portion among the plurality of the guide portions to move downward of the upper surface of the lower frame.

2. The storage and retrieval machine according to claim 1, wherein the lower frame has a frame shape, and the through region in the central portion of the lower frame is the guide portion movement region.

3. The storage and retrieval machine according to claim 1, in which the elevating/lowering portion is provided with side frames to which the guide portions are fixed, and a main frame that is fixed to the side frames and on which the transport device is installed, wherein
at least the lowermost guide portion among the plurality of the guide portions is installed to protrude downward of the side frame.

4. The storage and retrieval machine according to claim 1, wherein two of the masts are installed erect in parallel on the lower frame, a plurality of the guide portions are arranged in the elevating/lowering direction of the elevating/lowering portion with respect to each mast, and the elevating/lowering portion can be elevated/lowered between the masts.

5. The storage and retrieval machine according to claim 2, in which the elevating/lowering portion is provided with side frames to which the guide portions are fixed, and a main frame that is fixed to the side frames and on which the transport device is installed, wherein
at least the lowermost guide portion among the plurality of the guide portions is installed to protrude downward of the side frame.
